(19) United States
(12) Patent Application Publication
(10) Pub. No.: US 2005/0269028 A1
(43) Pub. Date: Dec. 8, 2005

(54) Method and apparatus for producing a multilayer storage media

(76) Inventors: Thomas Eisenhammer, Azmoos (CH); Bernd Heinz, Buchs (CH); Roger Loow, Sundbyberg (SE); Cem Yavaser, Azmoos (CH)

Correspondence Address: PEARNE & GORDON LLP, 1801 EAST 9TH STREET, SUITE 1200, CLEVELAND, OH, 44114-3108, US

(21) Appl. No.: 11/128,891

(22) Filed: May 13, 2005

Related U.S. Application Data
(60) Provisional application No. 60/571,839, filed on May 17, 2004.

(51) Int. Cl. B32B 31/00

(52) U.S. Cl. 156/281; 156/74

(57) ABSTRACT

A method and device for manufacturing a disc-shaped workpiece comprises the steps of producing a first and second disc-shaped substrate, applying an adhesive on at least one of the flat sides of said first and second substrates, bonding said substrates to form said disc-shaped workpiece and removing an excess of adhesive at the outer rim of the disc shaped workpiece by means of a liquid while rotating the workpiece on a rotating table. The liquid is being dispensed by a supply system comprising one or severeal nozzles, used liquid is collected by a suction device.

This invention concerns optical data storage media, especially in optical disc production, such as DVD-14/18, DVD R DL and other multilayer media.

### BACKGROUND OF THE INVENTION

The common way to produce a dual layer single side DVD (like a DVD-9) is to bond two 0.6 mm substrates together, each of which is carrying an information layer. Another way to manufacture a double layer disk is the so called “2P process”. Instead of forming one layer in each (two) substrate, the 2P process gives rise to a single substrate structure with two internal information layers. This is not necessary for DVD-9 production, but for other multilayer formats like DVD14/18 or DVDR9.

### RELATED ART

U.S. Pat. No. 6,117,284 and U.S. Pat. No. 6,309,496 describe general information relating to the 2P process.

In the first step of the 2P process a first substrate with an information layer is produced by injection moulding and coated with a layer material which is appropriate for the format. Then a second substrate is produced with a second information layer. This second substrate is then bonded together with the first substrate using typically an UV-curing adhesive. In the next step the 2 (bonded) substrates are separated whereby the UV resin with the image of the information layer of the second substrate must remain completely at the first substrate. Depending on the application it is also possible to transfer a metallic layer in a similar way from the second to the first substrate.

An overview is given in FIG. 1, representing Prior Art. For a good stamping result and an easy separation, the choice of material for the second substrate 2 is important. Whereas polycarbonate is typically used for the first substrate 1, PMMA or other nonpolar materials are used for the second substrate 2.

However, due to the nature of the bonding process there will be a certain amount of resin at the outer edge of the two substrates 4. Whereas this extra amount of adhesive 4 might be favourable for standard DVD production for a good sealing against the penetration of moisture it is a serious problem for the 2P process. After separation of the non-polar substrate this adhesive material remains connected to the bonding layer and/or the polycarbonate substrate. Due to its brittleness, the hardened adhesive forms a sharp rim around the substrate 1, so dust or particles can easily be created. Sticking on the surface of the media, these particles are significantly lowering the production yield.

Furthermore this sharp rim is causing process problems for the subsequent production steps. Such steps may be dye coating using a spinning process (in the case of DVD R DL) or final bonding to finish the DVD. This will be difficult if not measures are being taken to clean the outer edge.

In Prior Art this outer rim had been removed mechanically, e.g. by scraping or abrasion.

Solution According to the Invention

To solve the problem of adhesive around the outer edge according to this invention, the adhesive is removed from the outer edge in the low viscose state before final curing by using a liquid solvent. The liquid solvent is brought into contact with the outer edges of the 2 substrates to wash away the excess adhesive. The invention is also including all cases where a pre-curing or a partly curing is used for partial hardening the adhesive before doing the edge cleaning.

Therefore the inventive method for manufacturing a disc-shaped workpiece comprises the steps of producing a first and second disc-shaped substrate, applying an adhesive at least partially onto at least one of the flat sides of said first and second substrates and bonding said substrates to form said disc-shaped workpiece. Therafter the workpiece is being placed on a rotatable table (turn-table) and an excess of adhesive (e.g. a UC curabable adhesive) at the outer rim of the disc shaped workpiece is removed by means of a liquid, preferably a solvent. This can be achieved by directing the liquid to the outer rim of the disc shaped workpiece by means of at least one nozzle to wash away excess adhesive. A respective device to practice the inventive method comprises essentially a rotating table for the disc shaped workpiece, a surrounding cup and a supply system for the liquid. A further suction device for the liquid allows to remove the solvent after use. The distribution system for the solvent further comprises at least one nozzle, perferably a movable one, a tank and a valve. If at least two nozzles are being provided for, is is possible to direct direct the liquid to the outer rim of the disc shaped substrates from different positions and/or different directions.

### BRIEF DESCRIPTION OF THE DRAWINGS

FIG. 1 shows a Prior Art situation of two bonded substrates and a sharp outer edge.

FIG. 2 shows a cross section on two bonded substrates during a treatment according to an embodiment of the invention

FIG. 3 shows a top view of an installation on a disc during edge cleaning.

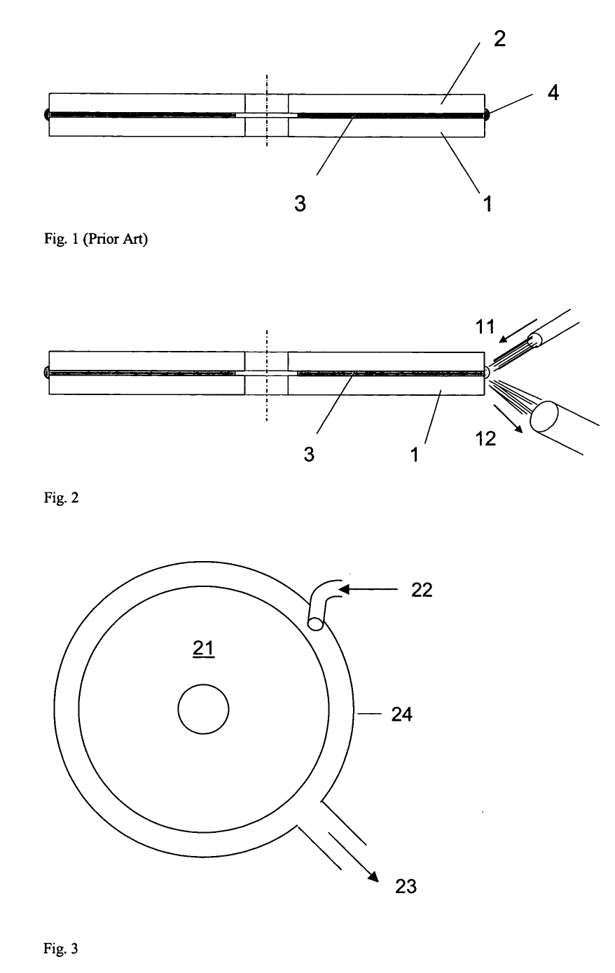

### DETAILED DESCRIPTION OF THE INVENTION

According to a special embodiment of the invention the 2 bonded substrates are placed on a rotating table and the solvent can be directed through a supply system 11 to the outer edge of two joined substrates. The supply system 11 will comprise a movable nozzle 22 to direct a stream of solvent directly to the edge of the disc 21, a valve and a pressure tank. Furthermore it might by advantageous to use more than one nozzle to bring the solvent into contact with the outer edge from different directions and/or at different positions. Waste solution and solved adhesive will be removed by rotating the disk and/or by a suction device 12, 23 and/or is dropping in a cup 24 surrounding the spinner device. The rotation of the bonded substrate is needed for creating an outwards directed force to the solvent drops, to prevent a flow of solvent to the inner area of the disk and to remove it from the edge. The suction device will be necessary due to a natural limitation of the allowed rotation speed. If the speed becomes too high, the adhesive between the two substrates will be spinned out to the edge. Sucking away the solvent and the solved adhesive allows a complete cleaning with moderate spinning speed.

The rotation of the bonded substrate is needed furthermore for a homogenous cleaning result.

Typical process parameters for the edge cleaning are:

| Solvent: | IPA | |
|---|---|---|
| Nozzle diameter | 0.2 | mm |
| Pressure tank p | 1 | bar |
| Volume IPA | 1 | ml |
| RPM/Direction | 1000/CW | |
| Cycle t | ˜5 | s |

In comparison of other techniques, where the outer edge of the disks is cleaned after the curing step, the removal of the adhesive from the outer edge in the uncured low viscose state avoids the risk of creating dust particles during cleaning. Those dust particles can be a potential reason for a low production yield.

### REFERENCE NUMERALS

1 first substrate, e.g. polycarbonate (PC)
2 second substrate, non-polar material, e.g. PMMA
3 bonding layer
4 unwanted adhesive at the outer edge
11 supply system for liquid (solvent)
12 suction device
21 disk
22 movable nozzle
23 suction device
24 cup

1. A method for manufacturing a disc-shaped workpiece comprising the steps of:
Producing a first and second disc-shaped substrate
Applying an adhesive at least partially onto at least one of the flat sides of said first and second substrates
Bonding said substrates to form said disc-shaped workpiece
Removing an excess of adhesive at the outer rim of the disc shaped workpiece by means of a liquid.

2. Method according to claim 1, wherein the adhesive is an UV curable adhesive.

3. Method according to claim 1, wherein the liquid is a solvent.

4. Method according to claim 1, wherein the liquid is directed to the outer rim of the disc shaped workpiece by means of at least one nozzle to wash away excess adhesive.

5. Method according to claim 1, wherein the disc shaped workpiece is being rotated during removal of the excess adhesive.

6. A device for removal of excess adhesive from a disc shaped workpiece comprising a rotating table for the disc shaped workpiece, a surrounding cup and a supply system for a liquid.

7. Device according to claim 6, further comprising a suction device for the liquid

8. Device according to claim 6, wherein the supply system comprises at least one nozzle, a tank and a valve.

9. Device according to claim 8, wherein the nozzle is movable.

10. Device according to claim 8 with at least two nozzles, directing the liquid to the outer rim of the disc shaped substrates from different positions and/or different directions.
